(19) United States
(12) Patent Application Publication
(10) Pub. No.: US 2014/0159638 A1
(43) Pub. Date: Jun. 12, 2014

(54) PORTABLE ENERGY HARVESTING, STORING, AND CHARGING DEVICE

(71) Applicant: EnergyBionics, LLC, Royal Palm Beach, FL (US)

(72) Inventor: Sean Lawrence Ebersold, Wellington, FL (US)

(73) Assignee: EnergyBionics, LLC, Royal Palm Beach, FL (US)

(21) Appl. No.: 13/968,917

(22) Filed: Aug. 16, 2013

Related U.S. Application Data
(60) Provisional application No. 61/684,768, filed on Aug. 19, 2012.

(51) Int. Cl. H02J 7/00; H02J 7/35; H02J 7/34

(52) U.S. Cl. CPC H02J 7/0068; H02J 7/34; H02J 7/35
USPC 320/101

(57) ABSTRACT

Embodiments of the present invention may provide a portable energy harvesting, energy storage and battery charging device. The portable device consistent with embodiments of the invention may be worn as, for example, a wrist application. The portable device may incorporate any one of, or a combination of, thermoelectric and solar energy harvesting technology as a source for charging, for example, at least one rechargeable battery. The energy may be stored for later use to, for example, recharge portable electronic devices on the go. In various embodiments, the portable device may be configured to provide a time, date and energy supply in a convenient display. Furthermore, the portable device may incorporate, into its design, integrated Universal Serial Bus (USB) connectors for convenient and direct charging of other portable electronic devices. The USB connector may also be configured to cause a charging of the battery of the portable device.

### RELATED APPLICATION

Under provisions of 35 U.S.C. §119(e), the Applicant claims the benefit of U.S. Provisional Application No. 61/684,786, filed on Aug. 19, 2012, which is incorporated herein by reference.

U.S. patent application Ser. No. 13/968,800 and Attorney Docket No. E4-SE001, filed on even date herewith in the name of the same Applicant and entitled “PORTABLE ENERGY HARVESTING, STORING, AND CHARGING DEVICE,” assigned to the assignee of the present application, is hereby incorporated by reference.

### BACKGROUND

A portable electronic device may be rendered useless when their batteries are depleted. Consequently, the use of portable electronic devices, such as cellular phones, handheld Personal Digital Assistants (PDA), MP3 Players, gaming devices, smart watches and the like may depend on rechargeable batteries for portability. This may often occur at a time that is not convenient for standard charging through, for example, a wall outlet to recharge the device battery. As a result, outdoor enthusiasts, travelers and tourists, and people who utilize portable electronic devices often experience battery depletion of their devices before they find a time or means to charge their device.

### BRIEF DESCRIPTION OF THE DRAWINGS

The accompanying drawings, which are incorporated in and constitute a part of this disclosure, illustrate various embodiments of the present invention. In the drawings:

FIG. 1 illustrates a portable device consistent with embodiments of the present invention;

FIG. 2A depicts a cut out view of a portable device consistent with embodiments of the present invention;

FIG. 2B depicts a side view of a portable device consistent with embodiments of the present invention;

FIG. 3 illustrates a portable device strap consistent with embodiments of the present invention;

FIG. 4A illustrates a portable device consistent with embodiments of the present invention;

FIG. 4B illustrates a cord and housing consistent with embodiments of the present invention;

FIG. 5A depicts a three dimensional view of a portable device consistent with embodiments of the present invention;

FIG. 5B depicts an interior view of a portable device consistent with embodiments of the present invention;

FIG. 6A depicts a front-side view of a portable device consistent with embodiments of the present invention;

FIG. 6B depicts a back-side view of a portable device consistent with embodiments of the present invention;

FIG. 7A depicts a first side view of a portable device consistent with embodiments of the present invention;

FIG. 7B depicts a second side view of a portable device consistent with embodiments of the present invention;

FIG. 8A illustrates a front-side view of a solar cell consistent with embodiments of the present invention;

FIG. 8B illustrates a back-side view of a solar cell consistent with embodiments of the present invention;

FIG. 9 illustrates a first circuit diagram consistent with embodiments of the present invention;

FIG. 10 illustrates a second circuit diagram consistent with embodiments of the present invention;

FIG. 11 is a table illustrating the input/output pins of a chip consistent with embodiments of the present invention; and

FIG. 12 is a block diagram for providing a computing device consistent with embodiments of the present invention.

### DETAILED DESCRIPTION

The following detailed description refers to the accompanying drawings. Wherever possible, the same reference numbers are used in the drawings and the following description to refer to the same or similar elements. While many embodiments of the present invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. The present disclosure may contain headers. It should be understood that these headers are used as references and are not to be construed in any way as limiting upon the subjected matter disclosed under the header.

Overview

Embodiments of the present invention may provide a portable energy harvesting, energy storage and battery charging device. The portable device may comprise any one of, or a combination of, thermoelectric and solar energy harvesting technology. The energy harvesting technology may serve as source for charging, for example, at least one rechargeable battery. The battery may be built into the portable device and store the energy produced by the energy harvesting technology. In turn, the harvested and stored energy may be employed to charge the battery of another electronic device that may be connected to the portable device.

Consistent with embodiments of the present invention, a means for conveying the energy stored by the portable device to a rechargeable battery of another electronic device may be provided. For example, a charging cord may accompany the portable device. In some embodiments, the charging cord may be integrated into the design of the portable device. The cord may, at one end, comprise a first input configured to interface with a connector of the portable device. At the other end, the cord may comprise a second input compatible to interface with a connector of the other electronic device. In some embodiments, the cord may be embedded into, for example, a strap attached to the portable device. In other embodiments, the cord may be provided in a housing separated from the portable device.

Still consistent with embodiments of the present invention, the connector of the portable device used to interface with the cord may also be configured to cause a charging of the battery of the portable device itself. For example, the second input of the cord may be a female connector enabling the travel of an energy supply into the portable device. In turn, the battery of the portable device may be charged. Accordingly, the connector of the portable may serve as yet another energy harvesting technology in addition to any thermoelectric and solar harvesting technology that may be incorporated into the portable device.

The portable device consistent with embodiments of the present invention may be worn around, for example, a user's wrist. In various embodiments, the portable device may be worn at another location on the body. In this way, a solar energy harvesting technology of the portable device may be constantly charging the battery of the portable device when the user wears the portable device in an area of the body that is regularly exposed to an energy source, such as the sun. Moreover, by keeping the portable device attached to the user's body, the thermoelectric energy harvesting technology of the portal device may be constantly charging the battery of the portable device from, for example, the heat radiating from the user's body.

Embodiments of the present invention may provide an opportunity for users who prefer the application and use of sustainable energy sources for powering their portable electronic devices. Some advantages over conventional portable charging devices may be found in, but are not limited to: embodiments comprising a design of the portable device to be worn on the wrist where it may be easily carried, available, and exposed to solar and thermal energy sources; embodiments comprising an integrated USB connector which may avoid a need for a separate USB cable for charging; and embodiments comprising a sustainable and renewable thermoelectric and solar harvesting technology to supply a near constant supply of power. Finally, embodiments of the present invention may use lithium ion battery technology which offers high power rechargeable batteries in a low profile design.

### EXAMPLE EMBODIMENTS

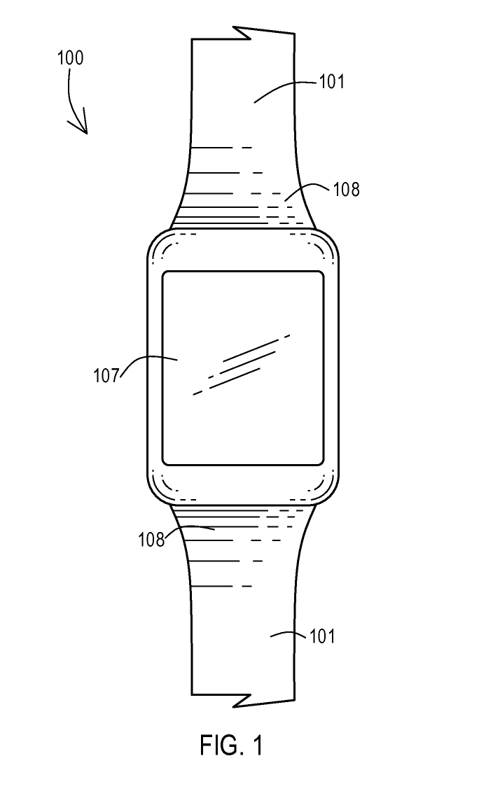

FIGS. 1-12 and the following description depict various embodiments of the present invention to teach those skilled in the art how to make and use the various embodiments of the present invention. Those skilled in the art will observe that the embodiments depicted can be combined and modified in various forms, including various assemblies and circuitry, to create other embodiments of the present invention.

FIG. 1 illustrates an embodiment of the present invention for providing a portable device 100. Portable device 100 may comprise a strap or band 101 used to secure the portable device to a user's wrist. Band 101 may enable portable device 100 to be worn similar to, for example, a wrist watch, smart watch, or the like. Portable device 100 may comprise a solar cell 107. In various embodiments, solar cell 107 may be a monocrystalline solar cell having dimensions suitable to sustain the portability of the portable device. By way of example and not limitation, one set of dimensions for solar cell 107 may be approximately 22×35×2 (mm). Being worn around the user's wrist, solar cell 107 may be exposed to both indoor and outdoor light sources.

Still consistent with embodiments of the present invention, portable device 100 may comprise at least one rechargeable battery 108. Battery 108 may be, for example, a lithium ion battery having dimensions suitable to sustain the portability of the portable device. By way of example and not limitation, one set of dimensions for battery 108 may be approximately 3.8×20×25 (mm). The at least one battery 108 may be designed within an interior of portable device 100 so as to be concealed from an exterior of portable device 100. In some embodiments, battery 108 may be concealed from view by being embedded within band 101. Electricity generated by the solar energy harvesting technology (i.e., solar cell 107) of portable device 100 may be used to recharge battery 108.

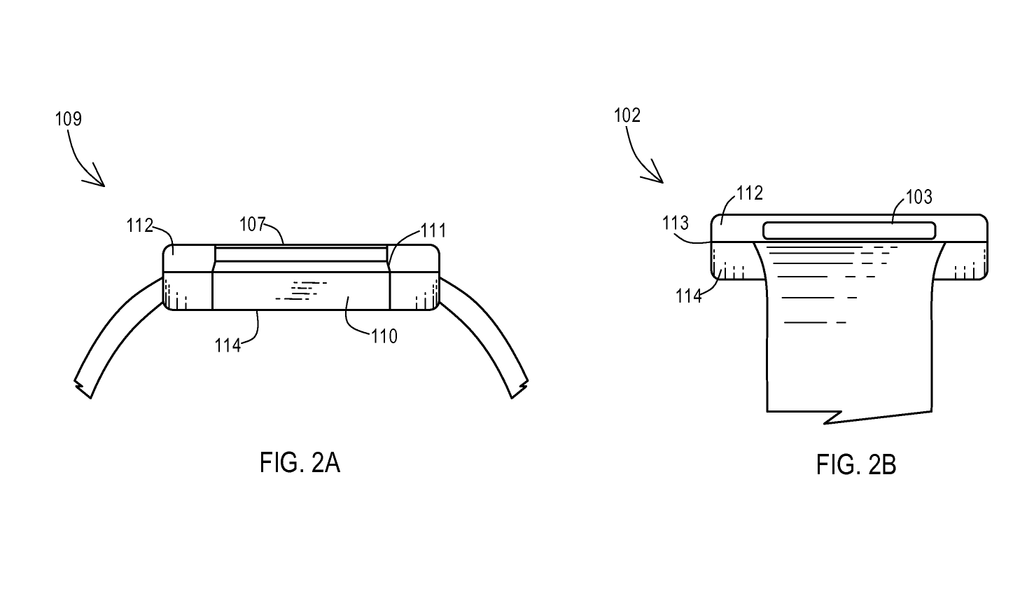

Furthermore, in some embodiments of the present invention, electricity may be generated with a thermoelectric generator in addition to solar cell 107. FIG. 2A illustrates a cutout view 109 of an embodiment of portable device 100 including a thermoelectric generator 110. Thermoelectric generator 110 may have dimensions suitable to sustain the portability of the portable device. By way of example and not limitation, one set of dimensions for thermoelectric generator 110 may be approximately 25×25×5 (mm).

Solar cell 107 and thermoelectric generator 110 may be integrated into a housing of the portable device. For example, the housing may be comprised of an upper portion 112 and lower portion 114. The upper portion 112 may be integrated with solar cell 107, while the lower portion 114 may be integrated with thermoelectric generator 110. To support efficient heat transfer, some embodiments may comprise a heat reservoir 111. Heat reservoir 111 may be placed, for example, in between thermoelectric generator 110 and solar cell 107. In certain embodiments, however, portable device 100 may not comprise thermoelectric generator 110 and/or heat reservoir 111.

Consistent with embodiments of the present invention, lower housing 114 may be comprised of an alloy plate. The allow plate may rest against the user's skin. In this way, body heat may be transferred through the alloy plate to thermoelectric generator 110. The body heat may be absorbed by thermoelectric generator 110 which may use the heat to generate electricity. In turn, the generated electricity may be employed to charge battery 108. In some embodiments, and as described with reference to FIG. 2B below, the absorbed heat may be subsequently radiated out to ambient air via upper portion 112.

FIG. 2B illustrates a side view 102 of an embodiment of portable device 100. As shown in FIG. 2B, portable device 100 may comprise a seam 113 indicating a break and subsequent thermal gap between the upper portion 112 and lower portion 114. Collectively, the heat reservoir 111 and upper portion 112 may serve as a heat sink, causing a thermal temperature difference that, in turn, may allow thermoelectric generator 110 to produce electricity from body heat and the interface of ambient air. The generated electricity by the thermoelectric energy harvesting technology may then be used to charge battery 108.

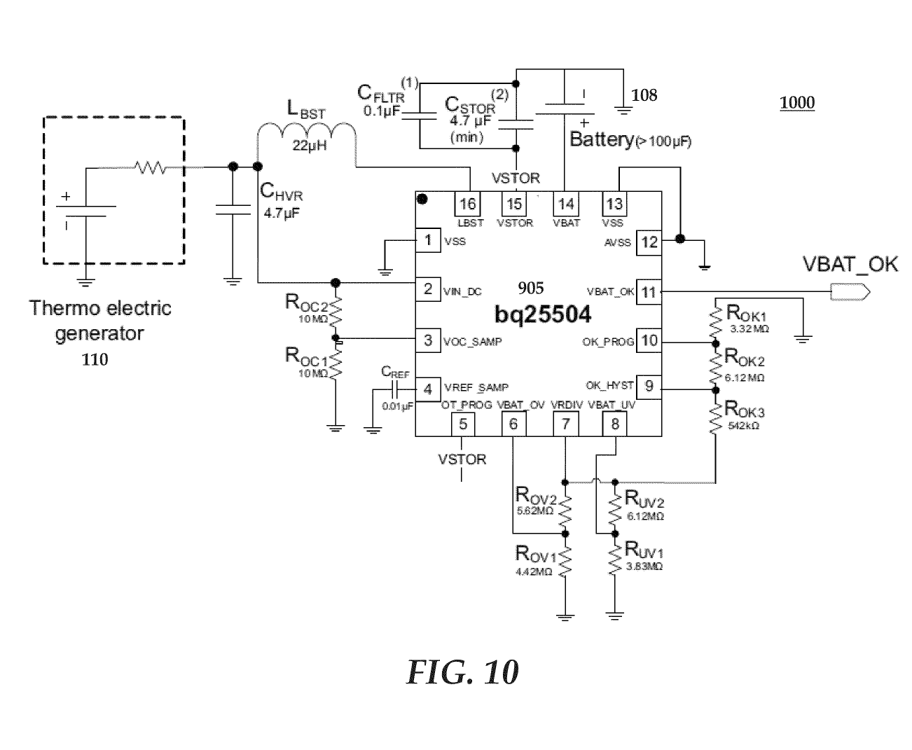

Portable device 100 may further comprise a display 103. Display 103 may be configured to indicate, for example, an energy level of at least one battery 108. In some other embodiments, display 103 may indicate a time and date. The display may comprise, but not be limited to, for example of a liquid-crystal display (LCD), light-emitting diode (LED), or plasma screen. In this way, portable device 100 may also serve as, for example, a watch. In some embodiments, display 103 may overlap or take a portion of an area in place of solar cell 107. The display may have the full capabilities of a watch, smart-watch, or other computing device as may be available to one of ordinary skill in the art at the time of the present invention. In this way, portable device may conveniently serve as a self-sustaining mobile computing device. Computing device is described in greater detail with reference to FIG. 10. In turn, self-sustaining mobile computing device may be operative to charge other electronic devices in accordance to the embodiments of the present invention.

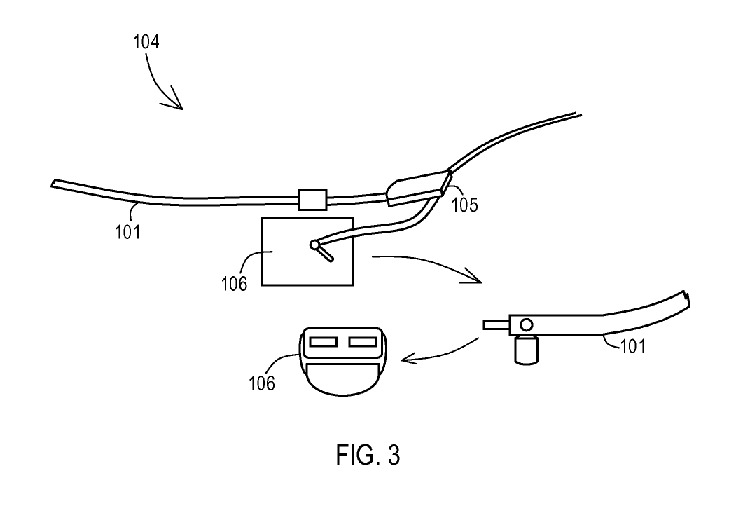

FIG. 3 illustrates a side view 104 of an embodiment of band 101. Band 101 may be comprised of, for example, two separate straps, each attached to portable device 100. The straps may be attached to portable device 100 by, for example, crimping the straps between the upper portion 112 and lower portion 114 of the housing. Moreover, the straps of band 101 may be attached to each other via a latching buckle 105. Latching buckle 105 may be configured to extend or lengthen a connection point of the straps so as to accommodate varying user wrist sizes.

Consistent with embodiments of portable device 100 may comprise both male and female USB connections 106. In some embodiments, wiring may be channeled from the housing of portable device 100 to host a micro-USB connector at, for example, an end of each strap. For example, a male micro-USB connector may be wired into a first strap of band 101. The male micro-USB connector may allow the direct connection from portable device 100 to a portable electronic device requiring a battery charge.

Similarly, a female micro-USB connector may be wired into a second strap of band 101. In some embodiments, the female micro-USB connector may be configured to be within the housing of portable device 100. The female micro-USB connection may enable the charging of at least one battery 108 via, for example, a power supply having a male USB connector configured to connect with the female USB connector of portable device 100. In other embodiments, the female micro-USB may be positioned next to the male micro-USB connector on the same strap.

In using portable device 100, a user may attach the device to his or her wrist and secure band 101 using buckle 105. The display 103 may indicate, along with the time and date, the energy level of the at least one battery 108. When at least one battery 108 has sufficient power, the user may simply connect the male micro-USB connection 106 to a female micro-USB connection on a portable electronic device in need of charging. Upon connection, portable device 100 may be configured to charge a battery of the connected portable electronic device by providing the connected portable device with its own stored energy supply.

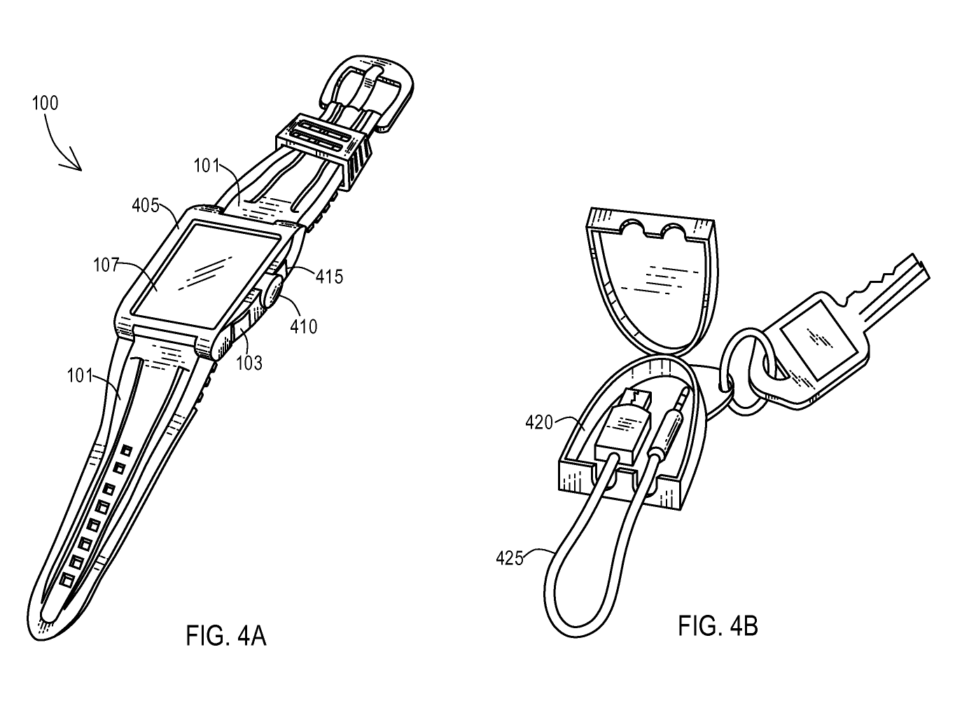

FIG. 4a illustrates another embodiment of portable device 100. As mentioned above, portable device 100 may be comprised of a housing 405. Housing 405 may be comprised of, but not limited to, for example, a stainless steel and/or an aluminum. By way of example and not limitation, a stainless steel housing may be of a 316L specification and an aluminum housing may be of a 6061-T6 specification. Portable device 100 may further comprise a connector 410. Connector 410 may be in the form of, for example, a crown of a watch. In some embodiments, the crown may be unscrewed to reveal connector 410.

Consistent with embodiments of the present invention, Connector 410 may be, for example, a 2.5 mm jack. Though reference is made throughout this disclosure to a 2.5 mm jack, other connectors and/or adapters may be used. The 2.5 mm jack may connect to a cord. The cord, as described above, may have the 2.5 mm jack at its first end with an adaptable jack at its second end. For instance, the cord may be adapted to a USB connector (e.g., micro-USB or nano-USB), an Apple connector, a fire wire connector, or any other connector capable of transferring energy supply to an electronic device capable of receiving the energy supply. FIG. 4B illustrates a cord 425 and a housing 420 for cord 425. In various embodiments, the housing may be configured to, for example, attach to a keychain. In this way, cord 425 may be portable along with portable device 100 and conveniently available to connect and charge electronic devices in accordance to embodiments of the present invention.

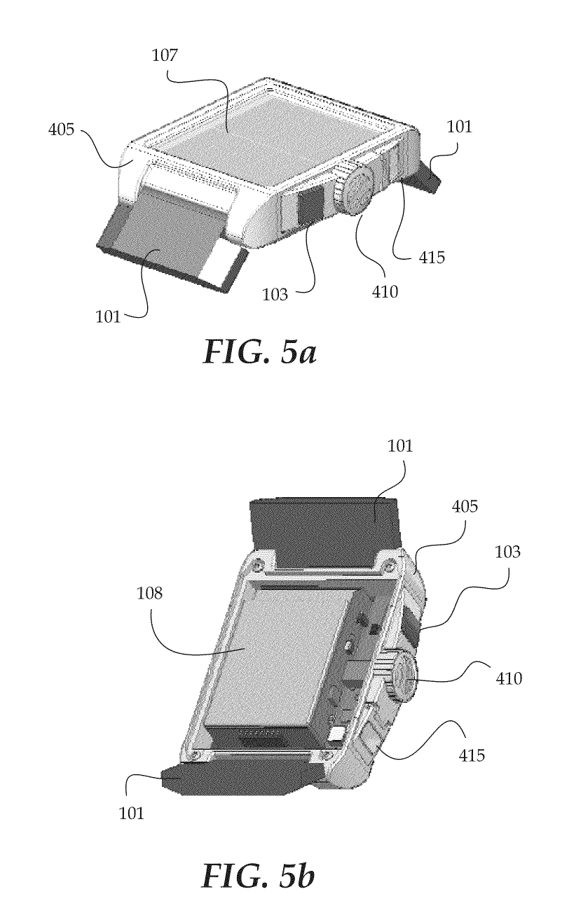

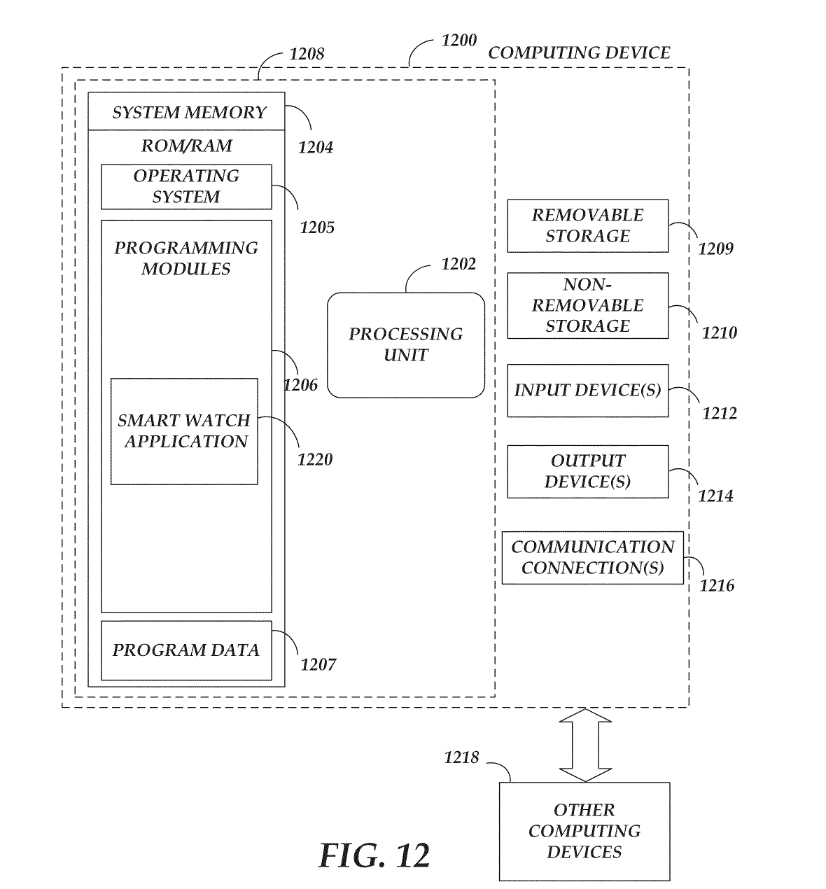

FIG. 5a illustrates portable device 100 in a three dimensional view consistent with embodiments of the present invention. Portable device 100 may comprise a push button 415. A depression of button 415 may be configured to cause, for example, display 103 to indicate an amount of energy supply remaining and/or stored within battery 108. In various embodiments, display 103 may indicate the energy supply within battery 108 with, for example, at least one color, image, graphic, text, digit, or any other suitable means for visually conveying energy level information. Still consistent with embodiments of the present invention, button 415 may serve as an input to a, for example, a computing device capable of providing, for example, standard watch functionality or a smart watch application in accordance to FIG. 12 below. Similarly, display 104 may serve as an output of the computing device disclosed with reference to FIG. 12.

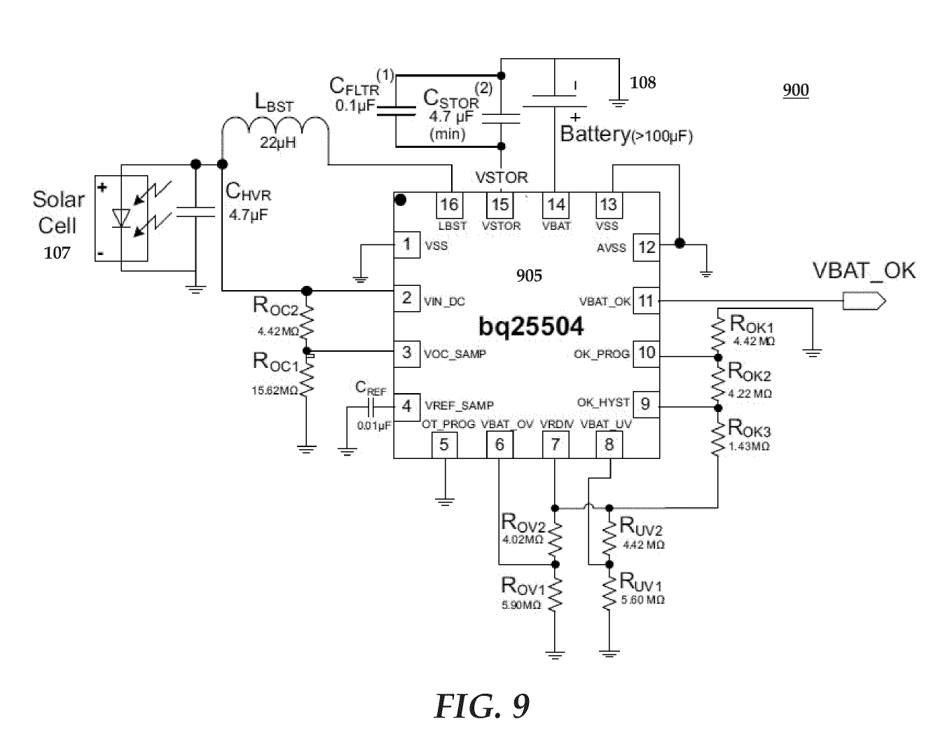

FIG. 5b illustrates an interior view of portable device 100 consistent with embodiments of the present invention. In various embodiments, battery 108 may be configured within housing 405 of portable device 100. Battery 108 may be coupled to, for example, solar cell 107 via various circuitry. As mentioned above, solar cell 107 may generate energy that, via the circuitry, may be stored in battery 108. The circuitry coupling solar cell 107 and battery 108 is described in greater detail with reference to FIG. 9.

Still consistent with embodiments of the present invention, battery 108 may be coupled to connector 410 so as to provide an output of its stored energy. Similarly, the coupling of battery 108 to connector 410 may enable battery 108 to receive an energy supply from an external source connected to connector 410. In this way, connector 410 may serve to both input energy to and output energy from portable device 100. Moreover, batter 108 may be further coupled to push button 410 and display 103 so as to enable their corresponding functionality in accordance to embodiments of the present invention.

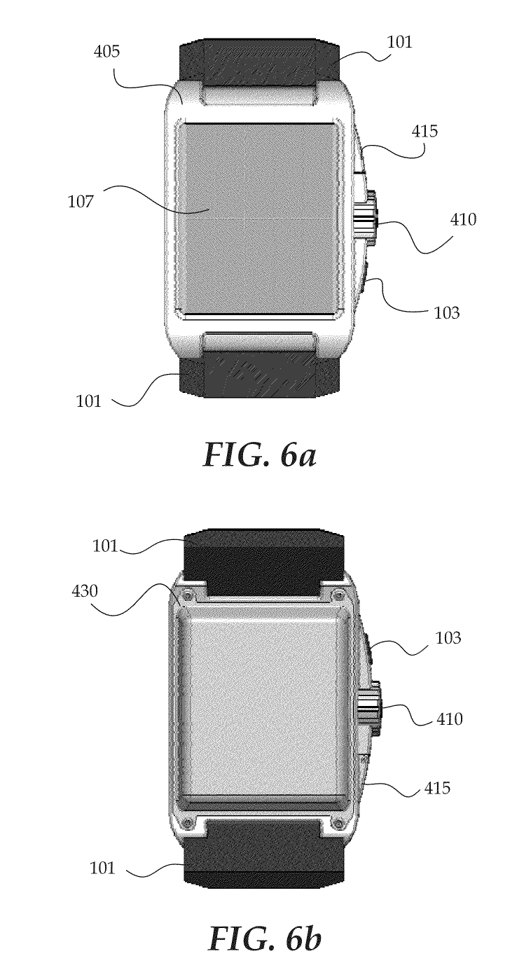

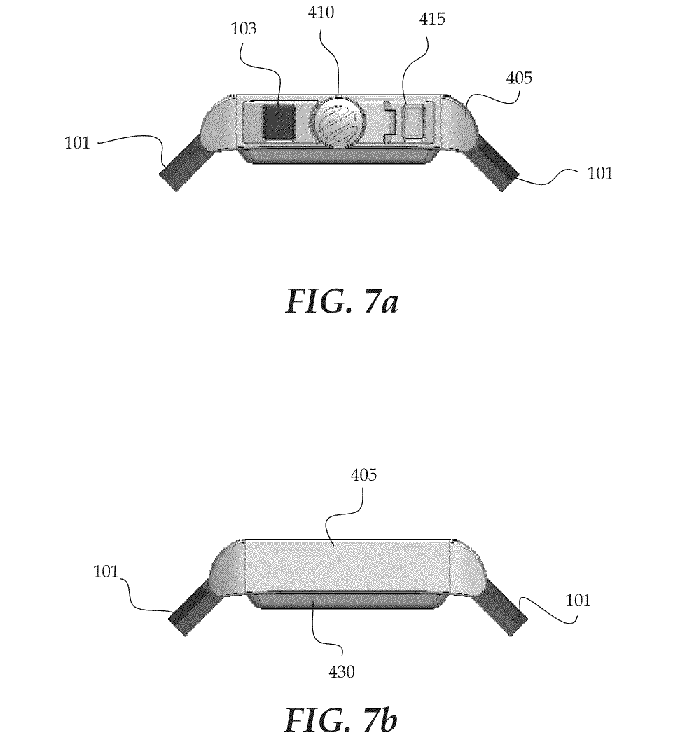

FIG. 6A depicts a front-side view of portable device 100 and FIG. 6B depicts a back-side view of portable device 100. FIG. 7A depicts a first side view of portable device 100 and FIG. 7B depicts a side view of portable device 100. It should be understood that the aforementioned views are provided as non-limiting examples to the various embodiments of the present invention. For example, FIG. 7A shows portable device 100 comprising a crown covering connector 410. Though portable device may comprise a crown covering connector 410, various embodiments may not comprise such cover. Moreover, FIGS. 6B and 7B show a thermo-conductive plate 430 integrated with housing 405. Thermo-conductive plate 430 may facilitate the transfer of heat from an exterior surface to an interior of portable device 100, where thermoelectric generator 110 may reside. Thermo-conductive plate 430 may not be necessary in embodiments of portable device 100 that do not comprise thermoelectric generator 110. Accordingly, the examples are used for illustrative purposes and various other designs may still be consistent with embodiments of the present invention.

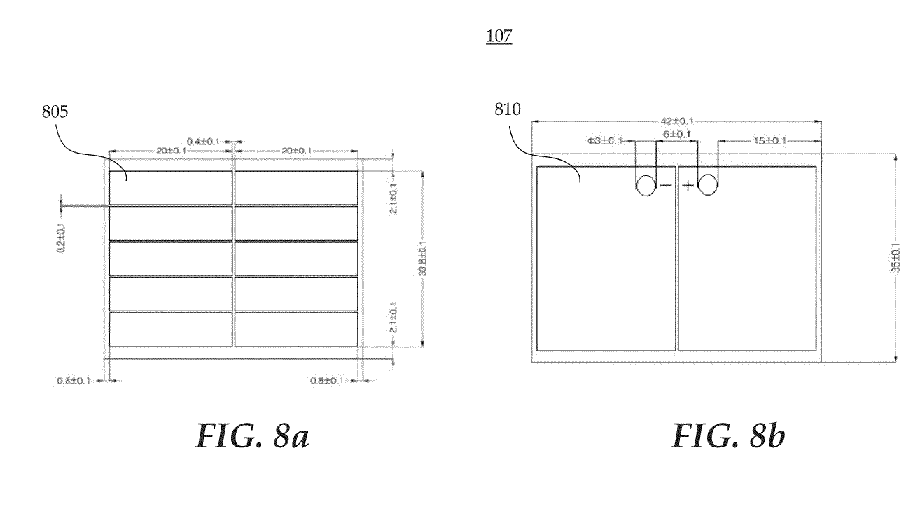

FIG. 8A illustrates a front-side view of solar cell 107 consistent with embodiments of the present invention. Solar cell 107 may be comprised of, for example, monocrystalline cells 805. In various embodiments cells 805 may have a spectral sensitivity range from 300 nm (near-ultraviolet) to 1100 nm (near-infrared), which includes visible light (400 to 700 nm). Due to this wide spectral range, they may be used in both indoor and outdoor applications. One advantage of using Monocrystalline (or single-crystalline) material is that they may not contain impurities. Consequently, the power conversion efficiency may not degrade over operating time. The power conversion efficiency of commercially available monocrystalline cells may range from 15 to 22%.

FIG. 8B illustrates a back-side view of solar cell 107 consistent with embodiments of the present invention. In various embodiments, solar cell 107 may be packaged with leads 810 coupled to each monocrystalline cell 805. In turn, and as will be described with greater detail in reference to FIG. 9, leads 810 may be coupled to the circuitry connecting to battery 108. In this way, solar cell 107 may provide its harvested energy to battery 108 for storage.

FIG. 9 illustrates a first circuit 900 consistent with embodiments of the present invention. Circuit 900 may be configured to receive energy from a solar cell 107 and channel the received energy from solar cell 107 to battery 108. In various embodiments, circuit 900 may comprise a processing chip 905. Processing chip may be, for example, but not limited to, a TI BQ25504 chip.

FIG. 10 illustrates a second circuit 1000 consistent with embodiments of the present invention. Circuit 1000 may be configured to receive energy from a thermoelectric generator 110 and channel the received energy from solar cell 107 to battery 108. In various embodiments, circuit 900 may comprise a processing chip 905. Processing chip may be, for example, but not limited to, a TI BQ25504 chip.

The BQ25504 is an intelligent integrated energy harvesting Nano-Power management solution that may meet the special needs of ultra-low power applications. The chip is designed to efficiently acquire and manage the microwatts (μW) to miliwatts (mW) of power generated from a variety of DC sources like photovoltaic (solar) or thermal electric generators. The BQ25504 implements a highly efficient boost converter/charger targeted toward products and systems, such as wireless sensor networks (WSN) which have stringent power and operational demands. The design of the BQ25504 starts with a DCDC boost converter/charger that requires only microwatts of power to begin operating.

Once started, the boost converter/charger can effectively extract power from low voltage output harvesters such as thermoelectric generators (TEGs) or single or dual cell solar panels. The boost converter can be started with VIN as low as 330 mV, and once started, can continue to harvest energy down to VIN=80 mV.

The BQ25504 also implements a programmable maximum power point tracking sampling network to optimize the transfer of power into the device. Sampling the VIN_DC open circuit voltage may be programmed using external resistors, and held with an external capacitor (CREF).

For example solar cells that operate at maximum power point (MPP) of 80% of their open circuit voltage, the resistor divider may be set to 80% of the VIN_DC voltage and the network will control the VIN_DC to operate near that sampled reference voltage. Alternatively, an external reference voltage may be provided by a MCU to produce a more complex MPPT algorithm.

The BQ25504 was designed with the flexibility to support a variety of energy storage elements. The availability of the sources from which harvesters extract their energy can often be sporadic or time-varying. Systems will typically need some type of energy storage element, such as a re-chargeable battery, super capacitor, or conventional capacitor. The storage element will make certain constant power is available when needed for the systems. The storage element also allows the system to handle any peak currents that cannot directly come from the input source.

To prevent damage to a customer's storage element, both maximum and minimum voltages may be monitored against the user programmed undervoltage (UV) and overvoltage (OV) levels. To further assist users in the strict management of their energy budgets, the BQ25504 may toggle the battery good flag to signal an attached microprocessor when the voltage on an energy storage battery or capacitor has dropped below a pre-set critical level. This may trigger the shedding of load currents to prevent the system from entering an UV condition. The OV, UV and battery good thresholds may programmed independently.

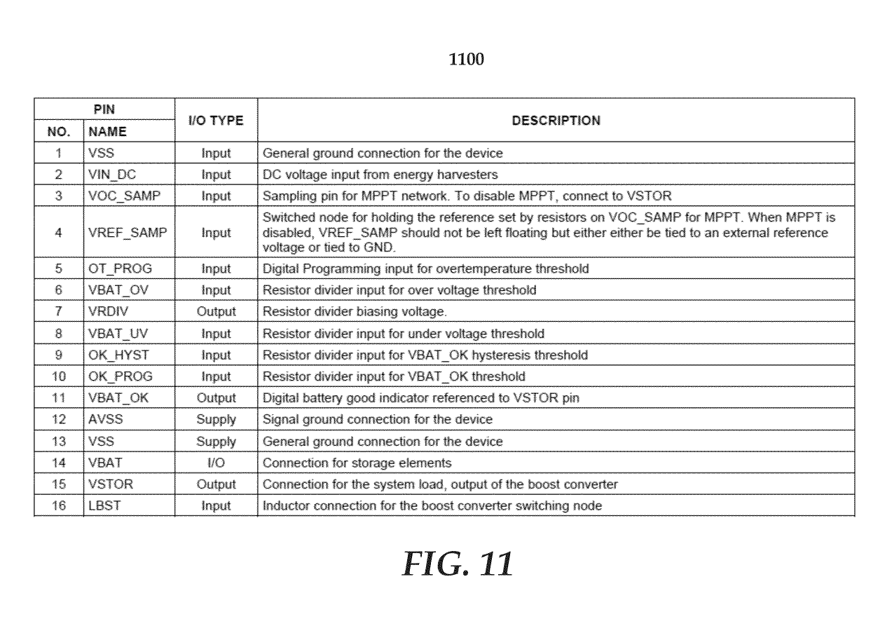

The capabilities of BQ25504 are packed into a small foot-print 16-lead 3 mm×3 mm QFN package, making it suitable for portable devices such as portable device 100. FIG. 11 shows the various input/output (IO) pins of the BQ25504 in a table 1100. The aforementioned description of the BQ25504 chip shall not be construed to limit the various embodiments of the present invention. Rather, the aforementioned description is only one example of chip 905 that may be used to perform the various functions of circuitry 900.

FIGS. 9-11 may represent various embodiments of circuitry that may be provided with portable device 100. For example, the aforementioned circuitry may be modified to combine and/or redesign circuits 900 and 1000 and fulfill the functions of the present invention. For example, embodiments of the present invention may make use of other circuitry that boosts the harvested energy received from the thermoelectric generator 110 and the solar cell 107. The circuitry may be combined or segregated, to an extent, for each energy harvesting device. Such circuitry may be positioned, for example, around thermoelectric generator 110 and solar cell 107 where it may deliver the energy harvested via wiring to the at least one battery 108.

Furthermore, additional wiring and circuitry may be employed to deliver regulated power from the at least one battery 108 to connector 410. For example, a first circuitry may be employed when connector 410 is to output energy while a second circuitry may be employed when connector 410 is to input energy. Such circuitry may be combined or segregated. Other circuitry and wiring may be employed to charge the at least one battery 108 when a power supply is connected to cord 425. The circuitry may be configured to, for example, charge the at least one battery 108 with the current passing through cord 425. Additional circuitry provides power to the time, date and energy level display 103. One example of such additional circuitry may be derived from FIG. 12.

FIG. 12 is a block diagram for providing a computing device 1200 consistent with embodiments of the present invention. In a basic configuration, computing device 1200 may include at least one processing unit 1202 and a system memory 1204. Depending on the configuration and type of computing device, system memory 1204 may comprise, but is not limited to, volatile (e.g. random access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include, for example, a smart watch application 1220. Other applications may be operative with embodiments of the invention, such as, but not limited to, for example, smart phone applications or personal digital assistant (PDA) applications. Furthermore, embodiments of the present invention may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and nonvolatile, removable and non-removable media implemented in any method or technology for storage of information, such as computer readable instructions, data structures, program modules, or other data. System memory 1204, removable storage 1209, and non-removable storage 1210 are all computer storage media examples (i.e memory storage.) Computer storage media may include, but is not limited to, RAM, ROM, electrically erasable read-only memory (EEPROM), flash memory or other memory technology, optical storage, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g. smart watch application 1220) may perform processes including, for example, one or more methods of providing the date, time, and energy level storage information as described above. The aforementioned process is an example, and processing unit 1202 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the present invention, program modules may include routines, programs, components, data structures, and other types of structures that may perform particular tasks or that may implement particular abstract data types. Moreover, embodiments of the present invention may be practiced with other computer system configurations, including hand-held devices, multiprocessor systems, microprocessor-based or programmable consumer electronics, minicomputers, mainframe computers, and the like. Embodiments of the present invention may also be practiced in distributed computing environments where tasks are performed by remote processing devices that are linked through a communications network. In a distributed computing environment, program modules may be located in both local and remote memory storage devices.

Furthermore, embodiments of the present invention may be practiced in an electrical circuit comprising discrete electronic elements, packaged or integrated electronic chips containing logic gates, a circuit utilizing a microprocessor, or on a single chip containing electronic elements or microprocessors. Embodiments of the present invention may also be practiced using other technologies capable of performing logical operations such as, for example, AND, OR, and NOT, including but not limited to mechanical, optical, fluidic, and quantum technologies. In addition, embodiments of the present invention may be practiced within a general purpose computer or in any other circuits or systems.

Embodiments of the present invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), and an optical fiber. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

All rights including copyrights in the illustrations included herein are vested in and the property of the Applicant. The Applicant retains and reserves all rights in the illustrations of portable device 100 included herein, and grants permission to reproduce the material only in connection with reproduction of the granted patent and for no other purpose.

While the specification includes examples, the present invention's scope is indicated by the following claims. Furthermore, while the specification has been described in language specific to structural features and/or methodological acts, the claims are not limited to the features or acts described above. Rather, the specific features and acts described above are disclosed as example for embodiments of the present invention.

The following is claimed:

1. An apparatus comprising:
a housing comprising an exterior portion and an interior portion;
a solar cell integrated within the exterior portion of the housing;
a battery, within the interior portion of the housing, coupled to the solar cell;
a connector coupled to the battery; and
at least one strap coupled to the housing.

2. The apparatus of claim 1, wherein the battery is configured to store energy harvested by the solar cell.

3. The apparatus of claim 1, wherein the connector is coupled to the battery so as to enable the battery to supply energy to the connector.

4. The apparatus of claim 1, wherein the connector is coupled to the battery so as to enable the battery to receive energy from the connector.

5. The apparatus of claim 1, further comprising:
a push button; and
a display.

6. The apparatus of claim 5, wherein the push button is configured to cause, upon depression, an indication to appear on the display.

7. The apparatus of claim 6, wherein the display is configured to indicate an energy level of the battery.

8. The apparatus of claim 1, wherein the connector is configured to receive an energy from an external energy supply.

9. The apparatus of claim 1, wherein the connector is configured to supply energy stored in the battery to an external electronic device.

10. The apparatus of claim 1, wherein the connector is configured to be connected to a charging cord.

11. The apparatus of claim 10, wherein the charging cord comprises a universal serial bus (USB) connector at one end.

12. The apparatus of claim 10, wherein the charging cord comprises a 2.5 mm jack at one end.

13. The apparatus of claim 10, further comprising a casing for the charging cord.

14. The apparatus of claim 1, wherein the connector is in the form of a crown of a watch.

15. The apparatus of claim 5, wherein the display is configured to indicate at least one of the following: a time and a date.

16. The apparatus of claim 1, wherein the at least one strap is enabled to wrap around a wrist of a user.

17. The apparatus of claim 16, further comprising at least one buckle configured to secure the at least one strap to the wrist of the user.

18. The apparatus of claim 1, further comprising a thermoelectric generator integrated within the exterior portion of the housing.

19. An apparatus comprising:
a housing;
a solar cell attached to the housing;
a battery coupled to the solar cell;
a connector coupled to the battery;
a first strap coupled to a first side of the housing; and
a second strap coupled to a second side of the housing.

20. An apparatus comprising:
a housing;
a monocrystalline solar cell attached to an upper portion of the housing;
a lithium ion battery;
a first circuit configured to:
couple the lithium ion battery to the monocrystalline solar cell, and
charge the lithium ion battery with energy harvested by the monocrystalline solar cell;
a connector;
a second circuit configured to:
couple the lithium ion battery to the monocrystalline solar cell to the connector, and
transfer energy from the lithium ion battery to the connector; and
a display indicating an amount of energy stored in the lithium ion battery.
